(19) United States
(12) Patent Application Publication
(10) Pub. No.: US 2020/0012625 A1
(43) Pub. Date: Jan. 9, 2020

(54) SYSTEM FOR IMPLEMENTING EXTENDED RECOGNITION MECHANISM IN A DISTRIBUTED LEDGER NODE

(71) Applicant: Bank of America Corporation, Charlotte, NC (US)

(72) Inventors: Govinda Rajulu Nelluri, Hyderabad (IN); Srinivasa Rao Dakshinyam, Hyderabad (IN)

(73) Assignee: Bank of America Corporation, Charlotte, NC (US)

(21) Appl. No.: 16/566,430

(22) Filed: Sep. 10, 2019

Related U.S. Application Data
(63) Continuation of application No. 16/011,852, filed on Jun. 19, 2018.

(51) Int. Cl. G06F 16/18; H04L 9/06

(52) U.S. Cl. CPC G06F 16/1865; G06F 9/541; H04L 2209/38; H04L 9/0643

(57) ABSTRACT

The present disclosure is directed to a novel system that incorporates extended recognition capabilities to a node in a distributed ledger network. In particular, a node within a distributed ledger network may be configured to simultaneously perform DLT functions while also performing information server and data management functions with respect to outside networked systems. By operating a multi-function DLT node with extended recognition mechanism in this way, an entity may efficiently distribute computing workloads when performing DLT and non-DLT functions.

### CROSS-REFERENCE TO RELATED APPLICATIONS

This application is a continuation of co-pending patent application Ser. No. 16/011,852, filed Jun. 19, 2018 and titled “SYSTEM FOR IMPLEMENTING EXTENDED RECOGNITION MECHANISM IN A DISTRIBUTED LEDGER NODE,” the entire disclosure of which is hereby incorporated herein by reference.

### FIELD OF THE INVENTION

The present disclosure embraces a system, computer program product, and computer-implemented method for implementing an extended recognition mechanism in a distributed ledger node. In particular, the system may use a multi-function node that simultaneously serves functions in a distributed ledger network and serve managed information outside networked systems.

### BACKGROUND

In the computer networking context, there is a need for an efficient interface between systems implementing distributed ledger technology (DLT) and legacy systems. In particular, it is desirable for a DLT system to be able to recognize instances in which extra value-added functionalities are embedded into them from non-DLT manufacturers.

### BRIEF SUMMARY

The following presents a simplified summary of one or more embodiments of the invention in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

The present disclosure is directed to a novel system that incorporates extended recognition capabilities to a node in a distributed ledger network. In particular, a node within a distributed ledger network may be configured to simultaneously perform DLT functions (e.g., participate in consensus, maintain a distributed ledger, or the like) while also performing information server and data management functions with respect to both outside networked systems (e.g., legacy systems) and in-network systems (e.g., DLT systems). By operating a multi-function DLT node with extended recognition mechanism in this way, an entity may efficiently distribute computing workloads when performing DLT and non-DLT (e.g., static data management) functions.

Accordingly, embodiments of the present disclosure provide a system for managing resources in a distributed ledger node. The system may comprise a processor; a communication interface; and a memory having a static data store, a copy of a distributed ledger, and executable code stored thereon. The executable code, when executed by the processor, may cause the processor to receive a resource management request from a legacy system; detect that completion of the resource management request requires a first set of static data; retrieve the first set of static data from the static data store; generate, using the first set of static data, a proposed data record, wherein the proposed data record; submit the proposed data record to a plurality of distributed ledger nodes; receive one or more validation responses from the plurality of distributed ledger nodes; determine, using a consensus algorithm, that the proposed data record is valid; and append the proposed data record to the copy of the distributed ledger.

In some embodiments, the resource management request comprises a request to convert resources in a first format to resources in a second format, wherein the executable code further causes the processor to determine, using the first set of static data, a conversion of a first amount of resources from the first format to the second format; and write a record of the conversion of the first amount of resources as a transaction within the proposed data record.

In some embodiments, the resource management request comprises a request to resources in a first format and resources in a second format to resources in a third format, wherein the executable code further causes the processor to detect that completion of the resource management request requires a second set of static data; determine that the first set of static data is associated with a rate of conversion between the first format and the third format; determine that the second set of static data is associated with a rate of conversion between the second format and the third format; determine, using the first set of static data, a conversion of a first amount of resources from the first format to the third format; determine, using the second set of static data, a conversion of a second amount of resources from the second format to the third format; and write a record of the conversion of the first amount of resources and the second amount of resources as a transaction within the proposed data record.

In some embodiments, the executable code further causes the processor to receive, from a first distributed ledger node, a request for a second set of static data; retrieve the second set of static data from the static data store; and transmit, over a network, the second set of static data to the first distributed ledger node.

In some embodiments, receiving and transmitting the second set of static data comprises communicating with the first distributed ledger node via a distributed ledger protocol.

In some embodiments, the executable code further causes the processor to receive, from the legacy system, a request for a second set of static data; retrieve the second set of static data from the static data store; and transmit, over a network, the second set of static data to the legacy system.

In some embodiments, the second set of static data comprises information on currently pending transactions within a distributed ledger network.

In some embodiments, receiving and transmitting the second set of static data comprises communicating with the legacy system via an API-based interaction.

Embodiments of the present disclosure also provide a computer program product for managing resources in a distributed ledger node. The computer program product may comprise at least one non-transitory computer readable medium having computer-readable program code portions embodied therein. The computer-readable program code portions may comprise executable portions for receiving a resource management request from a legacy system; detecting that completion of the resource management request requires a first set of static data; retrieving the first set of static data from the static data store; generating, using the first set of static data, a proposed data record, wherein the proposed data record; submitting the proposed data record to a plurality of distributed ledger nodes; receiving one or more validation responses from the plurality of distributed ledger nodes; determining, using a consensus algorithm, that the proposed data record is valid; and appending the proposed data record to a copy of the distributed ledger.

In some embodiments, the resource management request comprises a request to convert resources in a first format to resources in a second format, wherein the computer-readable program code portions further comprise executable portions for determining, using the first set of static data, a conversion of a first amount of resources from the first format to the second format; and writing a record of the conversion of the first amount of resources as a transaction within the proposed data record.

In some embodiments, the resource management request comprises a request to resources in a first format and resources in a second format to resources in a third format, wherein the computer-readable program code portions further comprise executable portions for detecting that completion of the resource management request requires a second set of static data; determining that the first set of static data is associated with a rate of conversion between the first format and the third format; determining that the second set of static data is associated with a rate of conversion between the second format and the third format; determining, using the first set of static data, a conversion of a first amount of resources from the first format to the third format; determining, using the second set of static data, a conversion of a second amount of resources from the second format to the third format; and writing a record of the conversion of the first amount of resources and the second amount of resources as a transaction within the proposed data record.

In some embodiments, the computer-readable program code portions further comprising executable portions for receiving, from the legacy system, a request for a second set of static data; retrieving the second set of static data from the static data store; and transmitting, over a network, the second set of static data to the legacy system.

Embodiments of the present disclosure also provide a computer-implemented method for managing resources in a distributed ledger node. The method may comprise receiving a resource management request from a legacy system; detecting that completion of the resource management request requires a first set of static data; retrieving the first set of static data from the static data store; generating, using the first set of static data, a proposed data record, wherein the proposed data record; submitting the proposed data record to a plurality of distributed ledger nodes; receiving one or more validation responses from the plurality of distributed ledger nodes; determining, using a consensus algorithm, that the proposed data record is valid; and appending the proposed data record to a copy of the distributed ledger.

In some embodiments, the resource management request comprises a request to convert resources in a first format to resources in a second format, wherein the method further comprises determining, using the first set of static data, a conversion of a first amount of resources from the first format to the second format; and writing a record of the conversion of the first amount of resources as a transaction within the proposed data record.

In some embodiments, the resource management request comprises a request to resources in a first format and resources in a second format to resources in a third format, wherein the method further comprises detecting that completion of the resource management request requires a second set of static data; determining that the first set of static data is associated with a rate of conversion between the first format and the third format; determining that the second set of static data is associated with a rate of conversion between the second format and the third format; determining, using the first set of static data, a conversion of a first amount of resources from the first format to the third format; determining, using the second set of static data, a conversion of a second amount of resources from the second format to the third format; and writing a record of the conversion of the first amount of resources and the second amount of resources as a transaction within the proposed data record.

In some embodiments, the method further comprises receiving, from the legacy system, a request for a second set of static data; retrieving the second set of static data from the static data store; and transmitting, over a network, the second set of static data to the legacy system.

In some embodiments, the second set of static data comprises information on currently pending transactions within a distributed ledger network.

In some embodiments, receiving and transmitting the second set of static data comprises communicating with the legacy system via an API-based interaction.

In some embodiments, the method further comprises receiving, from a first distributed ledger node, a request for a second set of static data; retrieving the second set of static data from the static data store; and transmitting, over a network, the second set of static data to the first distributed ledger node.

In some embodiments, receiving and transmitting the second set of static data comprises communicating with the first distributed ledger node via a distributed ledger protocol.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the disclosure in general terms, reference will now be made to the accompanying drawings, wherein:

FIG. 1 is a block diagram illustrating an operating environment for the extended recognition system, in accordance with some embodiments of the present disclosure;

FIG. 2 is a block diagram illustrating the extended recognition node, the first DLT node, and the legacy system in more detail, in accordance with some embodiments of the present disclosure; and

FIG. 3 is a process flow for the extended recognition system, in accordance with some embodiments of the present disclosure.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to elements throughout. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein.

“Entity” as used herein may refer to an individual or an organization that owns and/or operates an online system of networked computing devices, systems, and/or peripheral devices on which the extended recognition system described herein is implemented. The entity may be a business organization, a non-profit organization, a government organization, and the like.

“Entity system” as used herein may refer to the computing systems and/or other resources used by the entity to execute DLT and non-DLT functions.

“User” as used herein may refer to an individual who may interact with the entity system. Accordingly, the user may be an employee, associate, contractor, or other authorized party who may access, use, administrate, maintain, and/or manage the computing systems within the entity system.

“Computing system” or “computing device” as used herein may refer to a networked computing device within the entity system. The computing system may include a processor, a non-transitory storage medium, a communications device, and a display. The computing system may support user logins and inputs from any combination of similar or disparate devices. Accordingly, the computing system may be a portable electronic device such as a smartphone, tablet, single board computer, smart device, or laptop, or the computing system may be a stationary unit such as a personal desktop computer or networked terminal within an entity's premises. In some embodiments, the computing system may be a local or remote server which is configured to send and/or receive inputs from other computing systems on the network.

“Distributed ledger” or “distributed electronic ledger” as used herein may refer to a structured list of data records that is decentralized and distributed amongst a plurality of computing systems and devices. In some embodiments, the distributed ledger may be a blockchain ledger. “Node” as used herein may refer to a computing system on which the distributed ledger is hosted. Typically, each node maintains a full copy of the distributed ledger.

“Consensus,” “consensus algorithm,” or “consensus mechanism” as used herein may refer to the process or processes by which nodes come to an agreement with respect to the contents of the distributed ledger. Typically, changes to the ledger (e.g., addition of data records) may require consensus to be reached by the nodes in order to become a part of the authentic version of the ledger. The nodes may use various different mechanisms or algorithms to obtain consensus, such as proof-of-work (“PoW”), proof-of-stake (“PoS”), practical byzantine fault tolerance (“PBFT”), or the like.

“Resource” as used herein may refer an object which is typically transferred between the third party and the entity. The object may be tangible or intangible objects such as computing resources, data files, documents, funds, and the like.

Embodiments of the present disclosure provide a system, computer program product, and method for implementing extended recognition in a distributed ledger node. In particular, the system may comprise a plurality of nodes which host a distributed ledger maintained by a consensus mechanism, in which one of the plurality of nodes (which may be referred to herein as the “extended recognition node”) is configured to perform various additional functions. For instance, the extended recognition node may be configured to host an additional ledger or static data (e.g., data that is not replicated amongst the nodes of the distributed ledger) such that the extended recognition node may serve the static data to systems within an entity's legacy network. To this end, the extended recognition node may maintain its own database which is separate from the distributed ledger data hosted on the other nodes within the distributed ledger network. In some cases, the static data may further be used to execute certain processes (e.g., transactions) within the distributed ledger network. In other words, the other nodes within the distributed ledger network may access the static data to run certain processes even though the static data may not be considered a part of the replicated distributed ledger.

The distributed ledger network may be used to conduct and/or facilitate resource transfers from a first user to a second user. Depending on the nature of the resource transfer, the nodes within the distributed ledger network may require additional information to successfully complete the transfer. For instance, the first user may submit a request to send resources in a first format, while the second user may wish to receive the resources in a second format. Accordingly, the nodes may require additional data to convert the resources from the first format to a second format. In such embodiments, the required additional data may be stored as static data within the extended recognition node such that it may be accessed by the nodes to complete the resource transfer. In other embodiments, a user may submit a request to receive resources in two different formats. In such embodiments, the system may access the static data to convert to convert resources (which may be received from a second user) to the first format and/or the second format as specified by the first user.

The extended recognition system as disclosed herein addresses a number of technology-centric challenges. In particular, the extended recognition node supports both DLT and non-DLT protocols, which allows for the efficient integration of distributed ledger systems and legacy systems when executing processes. Furthermore, storing and serving static data via an in-network extended recognition node may reduce the computing resources (e.g., processing power, memory space, storage space, cache space, electric power, networking bandwidth, or the like) needed to serve and/or retrieve the static data.

The following description provides several exemplary use cases to further illustrate the system as described herein. For instance, the extended recognition system may be used to conduct and/or facilitate a resource transfer such as a cross-border transactions. In one embodiment, a first user residing in a first country (e.g., the United States) may submit, to the distributed ledger network, a transaction request to transfer a set amount of funds to a second user residing in a second country (e.g., India). In some embodiments, the transaction may require the conversion of funds from one currency to another (e.g., cross-currency transactions), which in turn may require the exchange of funds amongst a plurality of entities (e.g., financial institutions). In such embodiments, the extended recognition node may comprise a database of static data that may be required to complete the conversion (e.g., currency exchange rates). By housing the static data within the extended recognition node, the system may benefit not only from increased processing efficiency (e.g., lower latency when accessing the static data), but also from static data availability (e.g., database uptime).

In another exemplary embodiment, a first user may have an account with a first entity. The first user may request a transfer for funds of two different currencies from a second user, who may have an account with a second entity. In order to complete the transaction, the second entity may transact with a third and/or fourth entity to convert the funds in the second user's account to the currencies requested by the first user. In such embodiments, each entity (e.g., the first, second, third, and/or fourth entities) may each host a node of the distributed ledger. Accordingly, the second entity may host an extended recognition node which may comprise static data (e.g., conversion rates) that are needed by the second entity to execute the conversion of funds in anticipation of completing the transaction.

The extended recognition node may also serve additional functions as needed by the hosting entity. For instance, the entity may have a network of legacy computing systems which are not part of the distributed ledger network but still need to obtain information about transactions occurring within the distributed ledger network. In such embodiments, the extended recognition node may maintain an entity-specific ledger which may contain various types of data to be served to the legacy computing systems. In an exemplary embodiment, the extended recognition node may store a ledger of transactions which are currently pending in the distributed ledger network. In such embodiments, the extended recognition node may be configured to serve the data within the ledger of transactions to legacy systems within the entity for reporting purposes (e.g., through an application programming interface). In this way, the extended recognition system allows for an efficient integration of legacy systems and DLT systems to be more suitable for entity-specific use cases.

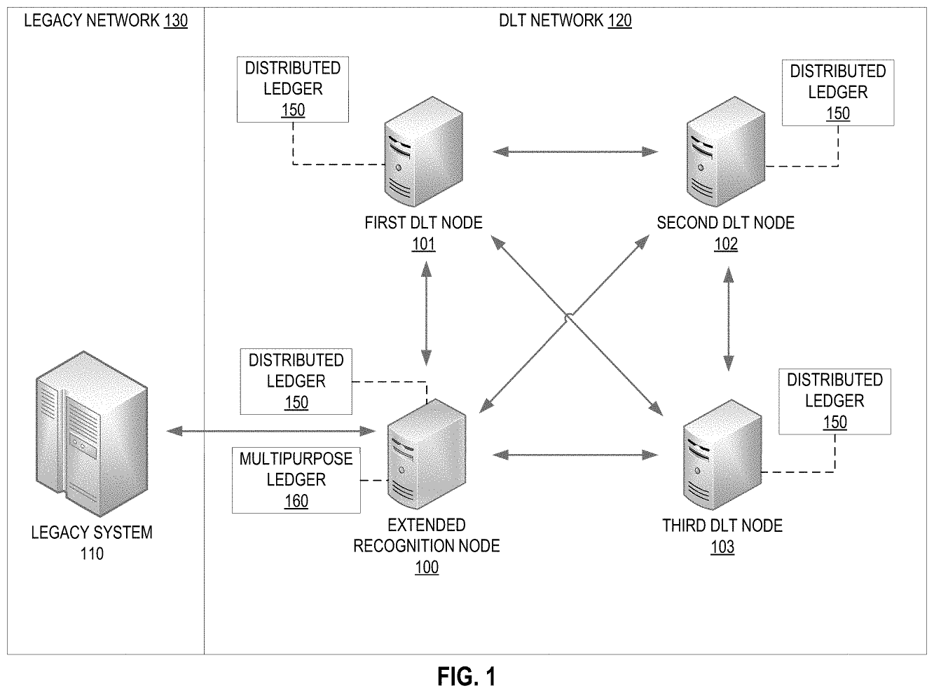

FIG. 1 is a block diagram illustrating an operating environment for the extended recognition system, in accordance with some embodiments of the present disclosure. In particular, the operating environment may include an extended recognition node 100 in operative communication with a plurality of DLT nodes 101, 102, 103 within a DLT network 120. The extended recognition node 100 The DLT network, as well as other networks as described herein, may be a global area network (GAN), such as the Internet, a wide area network (WAN), a local area network (LAN), or any other type of network or combination of networks. The network may provide for wireline, wireless, or a combination wireline and wireless communication between devices on the network.

The extended recognition node 100 and the DLT nodes 101, 102, 103 may be computing systems which each host a copy of the distributed ledger 150. Accordingly, the extended recognition node 100 and DLT nodes 101, 102, 103 are typically networked terminals or servers, but may also be desktop computers, laptops, smartphones or smart devices, IoT devices, or the like, or any combination thereof. The extended recognition node 100 is typically configured to perform all of the functions expected of a node within a distributed ledger network. In this regard, the extended recognition node 100 may communicate with the other nodes 101, 102, 103 via a first protocol (e.g., DLT-specific protocols such as consensus algorithms, smart contract logic, or the like). For instance, the extended recognition node 100 may participate in the consensus of determining the contents of the distributed ledger 150 (e.g., validating data records and/or approving or rejecting additional data records) with the other nodes 101, 102, 103 via a consensus algorithm. The extended recognition node 100 may additionally or alternatively be configured to execute smart contract logic to validate data records and/or sign transactions within the distributed ledger 150.

In addition to serving the DLT functions and communicating with the nodes within the DLT network 120, the extended recognition node 100 may additionally be configured to communicate with one or more legacy systems 110 over a network (e.g., an extended recognition mechanism may be injected into the extended recognition node 100 to provide the peripheral functions). In this regard, the extended recognition node 100 may further comprise a multipurpose ledger 160 which may contain data accessible to computing systems both inside and outside of the DLT network (e.g., both DLT nodes 101, 102, 103 and legacy systems 110). Typically, the multipurpose ledger 160 is not replicated across the DLT nodes 101, 102, 103. For instance, the multipurpose ledger 160 may contain data such as entity-specific data, or data needed to process transactions within the DLT nodes 101, 102, 103 that would be computationally inefficient to replicate across the nodes within the DLT network 120.

As used herein, “legacy system” may refer to a computing system that is external to the DLT network (e.g., does not participate in DLT functions). As such, the legacy system 110 may be a computing system (e.g., a networked terminal, laptop, desktop computer, server, or the like) within the entity's networks that is used to access the extended recognitions functions of the extended recognition node 100.

The extended recognition node 100 may, via an application programming interface (“API”), interact with legacy systems 110 to execute various value-added functions and/or services. For example, the extended recognition node 100 may maintain a separate ledger and/or database (e.g., a static data store) to serve data requests received from the legacy systems 110 and/or the nodes 101, 102, 103 within the DLT network. In an exemplary embodiment, a legacy system 110 may, via an API based interaction, submit a request to the extended recognition node 100 for data relating to transactions that are currently pending within the DLT network 120. In response, the extended recognition node 100 may retrieve the requested data from its static data store and serve the requested data to the legacy system 110 over the network. In some embodiments, the extended recognition node 100 may further maintain a log or audit of requests for static data within its database.

It should be understood by those having ordinary skill in the art that although the extended recognition node 100, the first DLT node 101, the second DLT node 102, the third DLT node 103, and the legacy system 110 are depicted as single units, each of the depicted components, or sub-components therein, may represent multiple units. In some embodiments, a given computing system as depicted in FIG. 1 may represent multiple systems configured to operate in a distributed fashion. For instance, the legacy system 110 may represent a plurality of computing systems operating in a distributed fashion. In other embodiments, the functions of multiple computing systems may be accomplished by a single system. For instance, the functions of the second DLT node 102 and the third DLT node 103 may, in some embodiments, be executed on a single computing system according to the entity's need to efficiently distribute computing workloads.

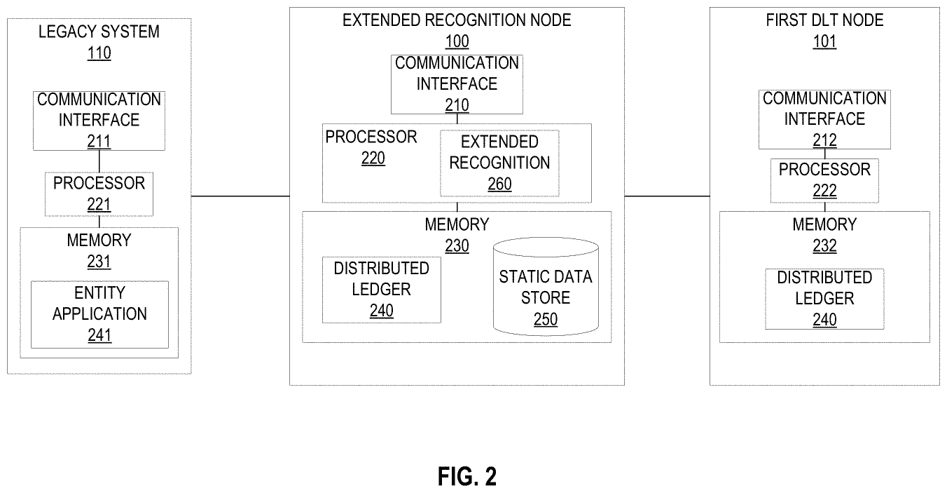

FIG. 2 is a block diagram illustrating the extended recognition node 100, the first DLT node 101, and the legacy system 110 in more detail, in accordance with some embodiments of the present disclosure. The extended recognition node 100 may comprise a processor 220 communicably coupled to such devices as a communication interface 210 and a memory 230. The processor 220, and other processors described herein, typically includes circuitry for implementing communication and/or logic functions of the computing systems or devices as described herein. For example, the processor 220 may include a digital signal processor device, a microprocessor device, and various analog to digital converters, digital to analog converters, and/or other support circuits. The extended recognition node 100 may use the communication interface 210 to communicate with other devices over the network 180. The communication interface 210 as used herein may include an Ethernet interface or other type of data port, an antenna coupled to a transceiver configured to operate on a cellular data, GPS, or WiFi signal, and/or a near field communication (“NFC”) interface. In some embodiments, a processing device, memory, and communication device may be components of a controller, where the controller executes one or more functions based on the code stored within the memory. The processor 220 may further comprise an extended recognition mechanism or module 260 which allows the processor 220 to execute various value-added functions implemented by the entity. In this way, the extended recognition node 100 may recognize and carry out the additional functionalities in parallel with its DLT-related functions.

The memory 230 of the extended recognition node 100 may comprise a copy of the distributed ledger 240 and a static data store 250. As used herein, memory includes any computer readable medium (as defined herein below) configured to store data, code, or other information. The memory may include volatile memory, such as volatile Random Access Memory (RAM) including a cache area for the temporary storage of data. The memory may also include non-volatile memory, which can be embedded and/or may be removable. The non-volatile memory can additionally or alternatively include an electrically erasable programmable read-only memory (EEPROM), flash memory or the like.

Typically, the extended recognition node 100, along with the other nodes within the DLT network, maintain a complete copy of the distributed ledger 240. The extended recognition node 100 may be configured to communicate with the other nodes (e.g., via a DLT-specific protocol) to determine the contents of the distributed ledger 240 stored thereon. For instance, the extended recognition node 100 may, via a consensus algorithm, determine the contents of the distributed ledger 240 (e.g., validate data records within the distributed ledger 240). In such embodiments, each node may comprise complete identical copies of the distributed ledger 240.

The static data store 250 may be a database containing data that is separate from the data records within the distributed ledger 240. In other words, in some embodiments, the static data within the static data store 250 is not replicated across the nodes within the DLT network. For example, the static data may include entity-specific data such as customer information, currently pending transactions within the DLT network, or the like. In such embodiments, the extended recognition node 100 may be configured to, via an API based interaction, receive static data requests from the legacy system 110. Upon receiving the static data request, the extended recognition node 100 may access static data according to the static data request and serve the static data to the legacy system 110 over the network. In an exemplary embodiment, a user within the entity's systems (e.g., a network administrator or other type of employee) may, via the legacy system 110, submit a request to the extended recognition node 100 for static data on the transactions that are currently being processed by the DLT network (e.g., the number of transactions, the type of transactions, the time at which the transactions started to be processed, or the like). Based on receiving the static data request from the user, the extended recognition node 100 may access the static data store 250, retrieve the static data relating to the pending transactions within the DLT network, and subsequently transmit the requested static data to the legacy system 110.

In some embodiments, the static data store 250 may further include static data that may be accessed by the legacy system 110 and the other DLT nodes 101, 102, 103 within the DLT network. For instance, the static data may include foreign exchange rate data which may be requested by users within the entity via the legacy system 110 and/or by the other DLT nodes 101, 102, 103 in order to process certain transactions (e.g., cross-border, cross-currency exchanges). In such embodiments, the extended recognition node 100 may further be configured to serve requests for static data received from the other nodes 101, 102, 103 in addition to requests received from the legacy system 110.

The first DLT node 101 may also comprise a processor 222 communicatively coupled with such devices as a communication interface 212 and a memory 232. It should be understood that while FIG. 2 depicts only the first DLT node 101, the first DLT node 101 may further represent the second DLT node 102 and/or the third DLT node 103. Typically, the memory 232 of the first DLT node 101 comprises a full copy of the distributed ledger 240. The copy of the distributed ledger 240 within the memory 232 of the first DLT node 101 may be identical to the copy of the distributed ledger 240 within the memory 230 of the extended recognition node 100, as the nodes 100, 101, 102, 103 may maintain the consistency of the distributed ledger via a consensus algorithm. In some embodiments, the first DLT node 101 may submit a request for specific static data within the static data store 250 of the memory 230 of the extended recognition node 100.

The legacy system 110 may also comprise a processor 222 communicatively coupled with such devices as a communication interface 211 and a memory 231. Typically, the legacy system 110 interacts with the extended recognition node 100 to access the extended recognition functions of the system (e.g., static data service and/or management). Accordingly, the legacy system 110 may be a desktop computer, networked terminal, laptop computer, tablet, smartphone, or the like. In some embodiments, the legacy system 110 may be configured to accept inputs from a user (e.g., an employee or client of the entity) who may use the legacy system 110 to access the features of the extended recognition node 100. In this regard, the legacy system 110 may further comprise a user interface, which may comprise the hardware and software implements to accept input from and provide output to the user. The user interface may comprise hardware such as a display, audio output devices, projectors, and the like, or input devices such as keyboards, mice, sensors, cameras, microphones, biometric input devices (e.g., fingerprint readers), and the like. The user interface may further comprise software such as a graphical or command-line interface through which the user may provide inputs and/or receive outputs from the legacy system 110. It should be understood that the display on which the user interface is presented may include an integrated display (e.g. a tablet or smartphone screen) within the legacy system 110, or an external display device (e.g. a computer monitor or television).

In other embodiments, the legacy system 110 may be used to submit a request to complete a resource transfer using the DLT network. The resource transfer may require the use of static data within the static data store 250 of the extended recognition node 100 in order to complete the transaction. Accordingly, upon receiving the request to complete the resource transfer, the extended recognition node 100 may utilize the relevant static data within its static data store 250 to submit a proposed data record to the nodes 101, 102, 103 within the DLT network. Once the nodes 100, 101, 102, 103 have determined, via a consensus algorithm, that the proposed data record is valid, each node (including the extended recognition node 100) may append the proposed data record to its complete copy of the distributed ledger.

In some embodiments, the resource transfer request may involve a transfer of resources from a first user to a second user, where the resources are sent from the first user in one or more first formats and the resources are received by the second user in one or more second formats. The extended recognition node may 100 detect that the conversion of resources from the one or more first formats to the one or more second formats may require the use of one or more sets of static data from within the static data store (e.g., a first set of static data corresponding to the conversion of resources from a first format to a second format, a second set of static data corresponding to the conversion of resources from a third format to a fourth format, or the like). In such embodiments, the extended recognition node 100 may pull the relevant sets of static data from the static data store 250 to convert resources from one format to another. Once the conversions have been made, the extended recognition node 100 may submit a proposed data record to the remaining nodes, where the proposed data record contains data related to the resource conversions. The remaining nodes may then evaluate the validity of the proposed data record using a consensus algorithm. If the proposed data record is found to be valid, each node may write the proposed data record to its copy of the distributed ledger.

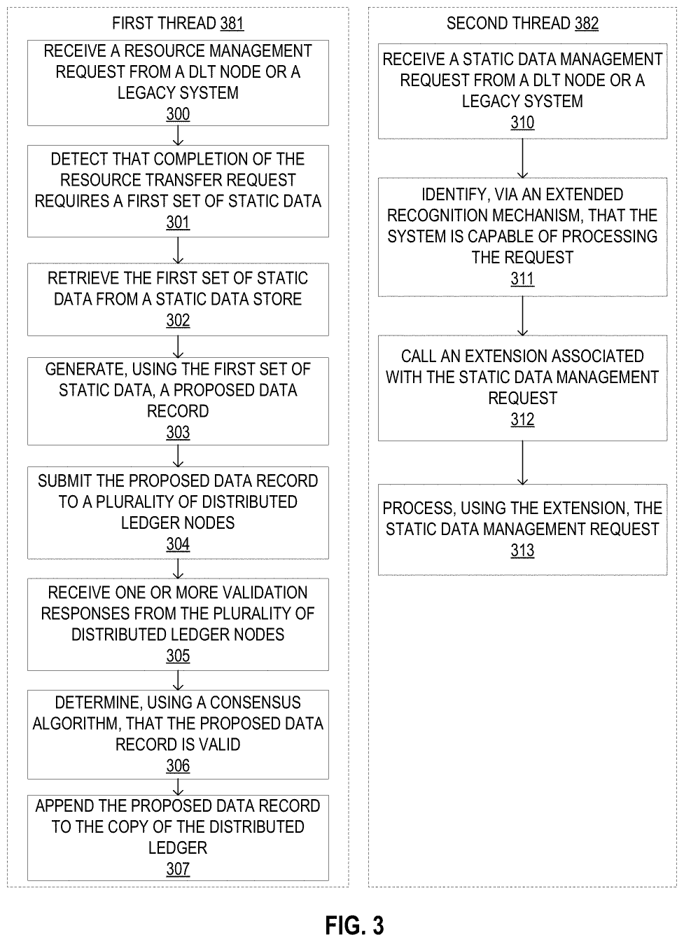

FIG. 3 is a process flow for the extended recognition system, in accordance with some embodiments of the present disclosure. The process begins at block 300, where the system receives a resource management request from a DLT node or a legacy system. Said process flow may be executed by the processor in a first thread 381. The resource management request may be, for example, a resource transfer request. In some embodiments, the resource transfer request may be submitted by a user on a legacy system who wishes to complete a transaction using the functionality of the DLT network. For example, a first user in a first location (e.g., the United States) may submit, using the legacy system 110, a request to transfer a set amount of resources in a first format (e.g., 1000 USD) from an account of the first user with a first financial institution (e.g., a bank) to an account of a second user with a second financial institution in a second currency (e.g., INR) in a second location (e.g., India). In other embodiments, the first user may submit a request to transfer a first amount of funds in a first currency (e.g., an “instruction” currency, such as USD) and a second amount of funds in a second currency (e.g., an additional instruction currency, such as GBP) to a second user, who wishes to receive the both amounts of funds in a third currency (e.g., a “target” currency, such as INR). Typically, the financial institutions involved in the resource transfer may each own and/or operate a node in the DLT network.

The process continues to block 301, where the system detects that completion of the resource transfer request requires the use of a first set of static data. For instance, the extended recognition node 100 may detect that in order to complete the transfer as requested, additional data (e.g., currency exchange data) is needed. Continuing the above example, the extended recognition node 100 may search its static data store for the relevant currency exchange rate (e.g., USD to INR, INR to USD, or the like) needed to complete the transaction. The extended recognition node 100, which in this example may be owned and/or operated by the first financial institution, may determine, using the USD to INR exchange rate data within its static data store, the amount of INR that the first financial institution should purchase (e.g., from a money market dealer or the like) in order to complete the requested resource transfer. In embodiments in which multiple exchanges are required (e.g., USD and GBP to INR), the extended recognition node 100 may determine that data for multiple exchange rates are required.

The process continues to block 302, where the system retrieves the first set of static data from a static data store. Continuing the example, the first set of data may be the currency exchange rate (e.g., USD to INR) needed to complete the resource transfer. Such currency exchange rate data, like other types of static data stored within the static data store, may be used for transactions originating from the DLT networks as well as from the legacy systems.

The process continues to block 303, where the system generates, using the first set of static data, a proposed data record, where the proposed data record comprises one or more transactions associated with the resource transfer request. Once the extended recognition node 100 has retrieved the necessary static data, the extended recognition node 100 may use the static data to determine the contents of the data record to be proposed to the remaining nodes within the distributed ledger. For instance, the data record may comprise a transaction in which the first financial institution purchases an amount of funds in INR are from a money market dealer (“MMD”) where the amount of funds purchased is determined using the currency exchange rate data retrieved from the static data store. The system may further determine the amount of funds to be deposited into the account of the second user, determined as a function of the amount of funds purchased from the MMD. Accordingly, the system may calculate a conversion of the specified amount of resources from one format to another, based on the specified amount, the first format (e.g., the input format) and the second format (e.g., the output format). After calculating the transactions involved in fulfilling the resource transfer request, the extended recognition node may write a record of the transactions (e.g., the conversion of resources) within a proposed data record to be submitted to the remaining DLT nodes within the DLT network.

The process continues to block 304, where the system submits the proposed data record to a plurality of distributed ledger nodes. In this example, the proposed data record may comprise transaction data and/or metadata which provides details about the resource transfer request. For instance, the proposed data record may include such information as the party requesting the resource transfer request, the endpoints of the transaction, the account information of the parties to the end-to-end transfer, the intermediate steps to be taken by the first financial institution (e.g., the purchase and or sale of funds from other financial institutions and/or MMD's in one or more different types of currencies), the amounts to be transferred as determined by the static data (e.g., currency exchange rate data), and the like. Once all of the data has been added to the proposed data record, the extended recognition node 100 may propagate the proposed data record to the remaining nodes within the DLT network. Once the nodes have received the proposed data record, each node may evaluate the contents of the proposed data record to ensure the proposed data record' s validity. For instance, the nodes may verify that the accounts involved in the resource transfer are valid, that the amounts being transferred are valid, or the like. Based on the results of the validation process, each

The process continues to block 305, where the system receives one or more validation responses from the plurality of distributed ledger nodes. In particular, the extended recognition node may receive responses from the remaining nodes within the DLT network. In some embodiments, the extended recognition may wait for a threshold number of validation responses to be received from the DLT nodes before proceeding to the next step of the process. In some embodiments, the validation responses may be validation “votes” which indicate whether each DLT node approves or rejects the proposed data record.

The process continues to block 306, where the system determines, using a consensus algorithm, that the proposed data record is valid. The extended recognition nodes, in addition to the remaining nodes in the DLT network, may use one or more of a number of different consensus algorithms to validate data records, such as PoW, PoS, PBFT, or the like. In some embodiments, the consensus algorithm may require the nodes to collect a threshold number of validation responses before validating proposed data records. For example, the consensus algorithm may require that a certain proportion (e.g., two-thirds) of all nodes within the DLT network to vote “yes” in order to validate data records.

The process concludes at block 307, where the system appends the proposed data record to the copy of the distributed ledger. Once the proposed data record has been validated using the consensus algorithm (e.g., a threshold number of nodes have voted “yes” to approve the proposed data record), each node within the DLT network may append the proposed data record to its copy of the distributed ledger. Typically, the existing contents of the distributed ledger may not be modified or deleted by the nodes; the distributed ledger may generally only be modified by appending data records. By adding data records via the consensus algorithm to an “append-only” distributed ledger, each node may ensure the integrity and validity of the data records within the distributed ledger and maintain consistency of data across all of the nodes within the DLT network.

Though the process flow as described in FIG. 3 is discussed with respect to a conversion of a resource in one format to another, it is within the scope of the present disclosure for the extended recognition system to support the use of multiple sets of static data to fulfill resource transfer requests. For instance, the resource transfer request may require conversion of resources from one or more first formats to one or more second formats. To illustrate, a first user may have a first account with a first financial institution which contains a certain amount of resources in a first format (e.g., a user has a bank account with an amount of funds in USD). Said first user may submit a request to transfer a first amount of resources in a first format (e.g., 1000 USD) and a second amount of resources in a second format (e.g., 1000 GBP) from the account of the first user to an account of a second user in the first format and the second format (e.g., the second user receives 1000 USD and 1000 GBP). Because the account of the first user contains funds in USD, the system may determine that a portion of the funds within the first user's account must be used to purchase the 1000 GBP to be transferred. To determine the amount of funds to be withdrawn from the first user's account, the extended recognition node may use rate of conversion static data (e.g., a USD to GBP currency exchange rate) to calculate the conversion of fund necessary to fulfill the resource transfer request.

In another exemplary embodiment, a first user with a first account with a first financial institution and a second account with a second financial institution may submit a request to transfer a first amount of funds in a first currency (e.g., 1000 USD) and a second amount of funds in a second currency (e.g., 1000 GBP) to a second user with a second account with a second financial institution, where the first amount of funds and the second amount of funds are to be received by a second user in a third currency (e.g., INR). In such embodiments, the first user may use the first account to transfer funds in the first currency and the second account to transfer funds in the second currency. The extended recognition node may determine that, in order to complete the transfer request, certain static data (e.g., data not replicated within the distributed ledger) is required to make the necessary calculations. For instance, the extended recognition node may pull a first set of static data (e.g., currency exchange data corresponding to USD and INR) and a second set of static data (e.g., currency exchange data corresponding to GBP and INR). After using the sets of static data to calculate the currency conversions, the extended recognition node, which may be owned and/or operated by the first financial institution, may generate a proposed data record which may contain transactions reflecting the steps needed to complete the resource transfer request (e.g., purchase amounts of INR corresponding to the amounts of USD and GBP being transferred, send the resulting amount of INR to the account of the second user, or the like). The extended recognition node may then submit the proposed data record, which contains the transactions needed to fulfill the resource transfer request, to the other nodes within the DLT network for validation.

The extended recognition node may further be configured to perform additional functions when interacting with the legacy system, which may be executed in parallel with the DLT functions of the extended recognition node, such as managing smart contracts, providing consensus of data records, or the like. In other words, the following process flow may be executed by the processor in a second thread 382 in parallel with the process flow in the first thread 381. The process begins at block 310, where the system receives a static data management request from a DLT node or a legacy system. For instance, the extended recognition node may receive, from the legacy system, a request for a particular set of static data within the static data store of the extended recognition node. In other embodiments, the extended recognition node may receive a request for transaction data from the legacy system. Typically, the extended recognition node is configured to communicate back and forth with the legacy system through an API-based interaction.

The process continues to block 311, where the system identifies, via an extended recognition mechanism, that the system is capable of processing the request. In particular, the processor may contain the capabilities to recognize the value-added functionalities implemented by the entity, and call upon said functionalities according to the requirements of the request received from the legacy system and/or the DLT nodes. The value-added functionalities may be referred to herein as “extensions” or “extended recognition modules” which may be implemented into the extended recognition framework.

The process continues to block 312, where the system calls an extension associated with the static data management request. At this stage, the processor may execute the extension or module which corresponds to the functions needed to process the request. For instance, if the static data management request contains a request to sort certain types of DLT transaction data based on the contents (e.g., whether the transaction data contains user data), the processor may call the “sorting extension” to execute the sorting functions necessary to process the request.

The process concludes at block 313, where the system processes, using the extension, the static data management request. Upon receiving the request for the set of static data, the extended recognition node may retrieve the set of static data from the static data store and transmit the set of static data to the legacy system. To illustrate, in an exemplary embodiment, a user of a legacy system may submit a request for a record of currently pending transactions and/or data records within the distributed ledger network. In such embodiments, the record of currently pending transactions may be stored as static data (e.g., not stored or replicated within the distributed ledger) within the static data store. The extended recognition node may retrieve the static data relating to currently pending transactions from the static data store and transmit said static data to the legacy system over the network. In an additional embodiment, the extended recognition node may receive a request for static data from one of the DLT nodes within the DLT network. In such embodiments, the extended recognition node may retrieve the static data and transmit it to the distributed ledger node using DLT-specific protocols.

The extended recognition mechanism allows the extended recognition node to be embedded with not only static data management functions, but also additional value-added services. For instance, an entity may implement a sorting service into the extended recognition node. The sorting service may be configured to separate certain distributed ledger transactions according to their type. For example, the sorting service may be configured to sort and retrieve only the DLT transactions which contain user data (e.g., customer information).

Each communication interface described herein generally includes hardware, and, in some instances, software, that enables the computer system, to transport, send, receive, and/or otherwise communicate information to and/or from the communication interface of one or more other systems on the network. For example, the communication interface of the user input system may include a wireless transceiver, modem, server, electrical connection, and/or other electronic device that operatively connects the user input system to another system. The wireless transceiver may include a radio circuit to enable wireless transmission and reception of information.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EEPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out the specialized operations of the present invention may be required on the specialized computer include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Embodiments of the present invention are described above with reference to flowcharts and/or block diagrams. It will be understood that steps of the processes described herein may be performed in orders different than those illustrated in the flowcharts. In other words, the processes represented by the blocks of a flowchart may, in some embodiments, be in performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for managing resources in a distributed ledger node, comprising:
a processor;
a communication interface; and
a memory having a static data store, a copy of a distributed ledger, and executable code stored thereon, wherein the executable code, when executed by the processor, causes the processor to:
receive a resource management request from a legacy system;
detect that completion of the resource management request requires a first set of static data;
retrieve the first set of static data from the static data store;
generate, using the first set of static data, a proposed data record, wherein the proposed data record;
submit the proposed data record to a plurality of distributed ledger nodes;
receive one or more validation responses from the plurality of distributed ledger nodes;
determine, using a consensus algorithm, that the proposed data record is valid; and
append the proposed data record to the copy of the distributed ledger.

2. The system of claim 1, wherein the resource management request comprises a request to convert resources in a first format to resources in a second format, wherein the executable code further causes the processor to:
determine, using the first set of static data, a conversion of a first amount of resources from the first format to the second format; and
write a record of the conversion of the first amount of resources as a transaction within the proposed data record.

3. The system of claim 1, wherein the resource management request comprises a request to resources in a first format and resources in a second format to resources in a third format, wherein the executable code further causes the processor to:
detect that completion of the resource management request requires a second set of static data;
determine that the first set of static data is associated with a rate of conversion between the first format and the third format;
determine that the second set of static data is associated with a rate of conversion between the second format and the third format;
determine, using the first set of static data, a conversion of a first amount of resources from the first format to the third format;
determine, using the second set of static data, a conversion of a second amount of resources from the second format to the third format; and
write a record of the conversion of the first amount of resources and the second amount of resources as a transaction within the proposed data record.

4. The system of claim 1, wherein the executable code further causes the processor to:
receive, from a first distributed ledger node, a request for a second set of static data;
retrieve the second set of static data from the static data store; and
transmit, over a network, the second set of static data to the first distributed ledger node.

5. The system of claim 4, wherein receiving and transmitting the second set of static data comprises communicating with the first distributed ledger node via a distributed ledger protocol.

6. The system of claim 1, wherein the executable code further causes the processor to:
receive, from the legacy system, a request for a second set of static data;
retrieve the second set of static data from the static data store; and
transmit, over a network, the second set of static data to the legacy system.

7. The system of claim 6, wherein the second set of static data comprises information on currently pending transactions within a distributed ledger network.

8. The system of claim 7, wherein receiving and transmitting the second set of static data comprises communicating with the legacy system via an API-based interaction.

9. A computer program product for managing resources in a distributed ledger node, the computer program product comprising at least one non-transitory computer readable medium having computer-readable program code portions embodied therein, the computer-readable program code portions comprising executable portions for:
receiving a resource management request from a legacy system;
detecting that completion of the resource management request requires a first set of static data;
retrieving the first set of static data from the static data store;
generating, using the first set of static data, a proposed data record, wherein the proposed data record;
submitting the proposed data record to a plurality of distributed ledger nodes;
receiving one or more validation responses from the plurality of distributed ledger nodes;
determining, using a consensus algorithm, that the proposed data record is valid; and
appending the proposed data record to a copy of the distributed ledger.

10. The computer program product of claim 9, wherein the resource management request comprises a request to convert resources in a first format to resources in a second format, wherein the computer-readable program code portions further comprise executable portions for:
determining, using the first set of static data, a conversion of a first amount of resources from the first format to the second format; and
writing a record of the conversion of the first amount of resources as a transaction within the proposed data record.

11. The computer program product of claim 9, wherein the resource management request comprises a request to resources in a first format and resources in a second format to resources in a third format, wherein the computer-readable program code portions further comprise executable portions for:
detecting that completion of the resource management request requires a second set of static data;
determining that the first set of static data is associated with a rate of conversion between the first format and the third format;
determining that the second set of static data is associated with a rate of conversion between the second format and the third format;
determining, using the first set of static data, a conversion of a first amount of resources from the first format to the third format;
determining, using the second set of static data, a conversion of a second amount of resources from the second format to the third format; and
writing a record of the conversion of the first amount of resources and the second amount of resources as a transaction within the proposed data record.

12. The computer program product of claim 9, the computer-readable program code portions further comprising executable portions for:
receiving, from the legacy system, a request for a second set of static data;
retrieving the second set of static data from the static data store; and
transmitting, over a network, the second set of static data to the legacy system.

13. A computer-implemented method for managing resources in a distributed ledger node, the method comprising:
receiving a resource management request from a legacy system;
detecting that completion of the resource management request requires a first set of static data;
retrieving the first set of static data from the static data store;
generating, using the first set of static data, a proposed data record, wherein the proposed data record;
submitting the proposed data record to a plurality of distributed ledger nodes;
receiving one or more validation responses from the plurality of distributed ledger nodes;
determining, using a consensus algorithm, that the proposed data record is valid; and
appending the proposed data record to a copy of the distributed ledger.

14. The computer-implemented method of claim 13, wherein the resource management request comprises a request to convert resources in a first format to resources in a second format, wherein the method further comprises:
determining, using the first set of static data, a conversion of a first amount of resources from the first format to the second format; and
writing a record of the conversion of the first amount of resources as a transaction within the proposed data record.

15. The computer-implemented method of claim 13, wherein the resource management request comprises a request to resources in a first format and resources in a second format to resources in a third format, wherein the method further comprises:
detecting that completion of the resource management request requires a second set of static data;
determining that the first set of static data is associated with a rate of conversion between the first format and the third format;
determining that the second set of static data is associated with a rate of conversion between the second format and the third format;
determining, using the first set of static data, a conversion of a first amount of resources from the first format to the third format;
determining, using the second set of static data, a conversion of a second amount of resources from the second format to the third format; and
writing a record of the conversion of the first amount of resources and the second amount of resources as a transaction within the proposed data record.

16. The computer-implemented method of claim 13, wherein the method further comprises:
receiving, from the legacy system, a request for a second set of static data;
retrieving the second set of static data from the static data store; and
transmitting, over a network, the second set of static data to the legacy system.

17. The computer-implemented method of claim 16, wherein the second set of static data comprises information on currently pending transactions within a distributed ledger network.

18. The computer-implemented method of claim 17, wherein receiving and transmitting the second set of static data comprises communicating with the legacy system via an API-based interaction.

19. The computer-implemented method of claim 13, wherein the method further comprises:
receiving, from a first distributed ledger node, a request for a second set of static data;
retrieving the second set of static data from the static data store; and
transmitting, over a network, the second set of static data to the first distributed ledger node.

20. The computer-implemented method of claim 19, wherein receiving and transmitting the second set of static data comprises communicating with the first distributed ledger node via a distributed ledger protocol.
